(19) United States
(12) Patent Application Publication
(10) Pub. No.: US 2012/0062727 A1
(43) Pub. Date: Mar. 15, 2012

(54) PART-MOUNTING SYSTEM

(75) Inventors: Kenichi Kaida, Osaka (JP); Kenichiro Ishimoto, Yamanashi (JP)

(73) Assignee: PANASONIC CORPORATION, Osaka (JP)

(21) Appl. No.: 13/320,814

(22) PCT Filed: Oct. 7, 2010
(86) PCT No.: PCT/JP2010/006023

§ 371 Date: Nov. 16, 2011

(30) Foreign Application Priority Data
Oct. 8, 2009 (JP) 2009-234040

(51) Int. Cl. H04N 7/18

(52) U.S. Cl. 348/87; 348/E07.085

(57) ABSTRACT

It is an objective to provide a part-mounting system that makes it possible to quickly ascertain a defective judgment location and input a result of judgment of the defective judgment location even if an operator is away from an inspection portion when the inspection portion has found a defective judgment location. An image of a location on a substrate Pb where a print status of solder Sd or a mounted status of parts Pt is judged as being defective by an inspection portion is displayed on all image display portions 31 of a plurality of operation panels 30 or some of the image display portions 31 selected by an operator OP. Through an operation input portion 32 of the operation panel 30 including the image display portion 31 on which the image of the defective judgment location is displayed, the operator OP can input a result of judgment made as to whether or not the print status of the solder Sd or the mounted status of the parts Pt at the defective judgment location is defective.

### TECHNICAL FIELD

The present invention relates to a part-mounting system having a solder printing portion for printing solder on a substrate, a part-mounting portion for mounting the solder-printed substrate with parts, and an inspection portion for judging whether or not a state of solder printed on the substrate or a state of parts mounted on the substrate is nondefective.

### BACKGROUND ART

A part-mounting system that manufactures mounted substrates by mounting parts on substrates has a solder printing portion for printing solder on a loaded substrate and a part-mounting portion for mounting parts on the substrate printed with solder by the solder printing portion. The solder printing portion and the part-mounting portion each are provided with an image display portion for outputting an operating command image to an operator (e.g., Patent Document 1). The part-mounting system has an inspection portion that captures an image of the solder on the substrate to thereby judge from the image whether or not a state of the printed solder is nondefective or captures an image of the parts on the substrate to thereby judge from the image whether or not a state of the mounted parts is nondefective. Thus, producing mounted substrates while the state of the printed solder remains defective or while the state of the mounted parts remains defective is prevented.

Criteria on which the inspection portion of the part-mounting system makes a judgment as to whether or not mounted parts are defective are usually set to a somewhat rigorous level in order to prevent occurrence of defectives as much as possible. There is a case where even a location at which the state of the printed solder or the state of the mounted parts has been judged to be defective by the inspection portion (i.e., a defective judgment location) can be judged to be nondefective by an operator. For this reason, a related art part-mounting system has hitherto been configured as follows. Namely, a captured image of the defective judgment location is displayed on an image display portion provided in the inspection portion. Viewing the image of the defective judgment location on the image display portion, the operator judges whether or not the defective judgment location is defective. A judgment result can be input through an operation input portion disposed in the vicinity of the image display portion. When the operator has made an input to the effect that the state of the printed solder or the state of the mounted parts on the image display portion at the defective judgment location is judged to be defective, the defective judgment location is processed as a defective location. In contrast, when the operator has made an input to the effect that the state is not judged to be defective, the defective judgment location is dealt as a good location (a nondefective location).

### RELATED ART DOCUMENT

### Patent Document

Patent Document 1: JP-A-2009-94270

### SUMMARY OF THE INVENTION

### Problem that the Invention is to Solve

However, the related art part-mounting system has the following drawback. If the operator is away from the inspection portion when the inspection portion has found a defective judgment location, the operator must bother to move to the inspection portion in order to ascertain the defective judgment location from the image on the image display portion of the inspection portion and to input a result of judgment of the displayed defective judgment location. Meanwhile, operation of the part-mounting system is halted, which may result in deterioration of productivity of mounted substrates.

Accordingly, the present invention aims at providing a part-mounting system that makes it possible to quickly ascertain a inspection-machine-cum-part-mounting machine and input a result of judgment of the defective judgment location even if an operator is away from an inspection portion when an inspection portion has found a defective judgment location.

### Means for Solving the Problem

A part-mounting system of a first invention comprises:

a solder printing portion that prints solder on a loaded substrate;

a part-mounting portion that mounts parts on the substrate printed with the solder by the solder printing portion;

an inspection portion that captures an image of the solder printed on the substrate by the solder printing portion or an image of the parts mounted on the substrate by the part-mounting portion and that judges from the captured image whether or not a print status of the solder on the substrate or a mounted status of the parts on the substrate is defective;

a plurality of input/output devices that each have an image display portion for displaying an image and an operation input portion through which an operator performs input operation; and

a display controller that lets all of the image display portions of the plurality of input/output devices or some of the image display portions selected by the operator display an image of a defective judgment location on the substrate where the print status of the solder or the mounted status of the parts is judged to be defective by the inspection portion, wherein

the inspection portion deals with the defective judgment location as a no-good location when an input meaning that the print status of the solder or the mounted status of the parts at the defective judgment location displayed on the image display portions is admitted to be defective has been made through the operation input portion of the input/output device having the image display portion on which the image of the defective judgment location is displayed by the display controller, and deals with the defective judgment location as a good location when an input meaning that the print status of the solder or the mounted status of the parts at the defective judgment location displayed on the image display portions is not admitted to be defective has been made.

A part-mounting system of a second invention is based on the part-mounting system of the first invention, further comprises:

a portable terminal that is carried by the operator and that includes a display for displaying an image and an input portion through which the operator performs input operation, wherein the display controller displays, on the display of the portable terminal, an image of the defective judgment location on the substrate where the print status of the solder or the mounted status of the parts is judged to be defective by the inspection portion; and wherein

the inspection portion deals with the defective judgment location as a no-good location when an input meaning that the print status of the solder or the mounted status of the parts at the defective judgment location displayed on the display of the portable terminal is admitted to be defective has been made through the input portion of the portable terminal, and deals with the defective judgment location as a good location when an input meaning that the print status of the solder or the mounted status of the parts at the defective judgment location displayed on the display of the portable terminal is not admitted to be defective has been made.

### ADVANTAGE OF THE INVENTION

In the present invention, an image of a location on a substrate where a print status of solder or a mounted status of parts is judged as being defective by an inspection portion is displayed on all image display portions of a plurality of input/output devices or some of the image display portions selected by an operator. Through an operation input portion of the input/output device including the image display portion on which the image of the defective judgment location is displayed, the operator can input a result (a judgment result) of judgment made as to whether or not the print status of the solder or the mounted status of the parts at the defective judgment location is defective. Therefore, it is possible to quickly ascertain defective judgment location and input a result of judgment of the defective judgment location even if an operator is away from an inspection portion when the inspection portion has found a defective judgment location. Since the operator becomes unnecessary to move to the inspection portion, operation of the part-mounting system is not halted, so that deterioration of productivity of mounted substrates can be prevented.

### BRIEF DESCRIPTION OF THE DRAWINGS

FIG. 1 is an oblique perspective view of a part-mounting system of a first embodiment of the present invention.

FIG. 2 is a configuration diagram of the part-mounting system of the first embodiment of the present invention.

FIG. 3 is a plan view of an inspection-machine-cum-part-mounting machine making up the part-mounting system of the first embodiment of the present invention.

FIG. 4 is a side view of the inspection-machine-cum-part-mounting machine making up the part-mounting system of the first embodiment of the present invention.

FIG. 5 is a portion diagram showing a control system of the inspection-machine-cum-part-mounting machine making up the part-mounting system of the first embodiment of the present invention.

FIG. 6 is a drawing showing an example image of solder on a substrate captured by an inspection camera provided in the inspection-machine-cum-part-mounting machine of the first embodiment of the present invention.

FIG. 7 is a plan view of a part-mounting machine making up the part-mounting system of the first embodiment of the present invention.

FIG. 8 is a side view of the part-mounting machine making up the part-mounting system of the first embodiment of the present invention.

FIG. 9 is a portion diagram showing a control system of the part-mounting machine making up the part-mounting system of the first embodiment of the present invention.

FIG. 10 is a drawing for describing operation for mounting parts on a substrate by means of a mount head provided in the part-mounting machine of the first embodiment of the present invention.

FIG. 11 is a drawing showing an example image of parts on the substrate captured by the inspection camera provided in the inspection-machine-cum-part-mounting machine of the first embodiment of the present invention.

FIG. 12 is a configuration diagram of a part-mounting system of a second embodiment of the present invention.

### EMBODIMENTS OF INVENTION

### First Embodiment

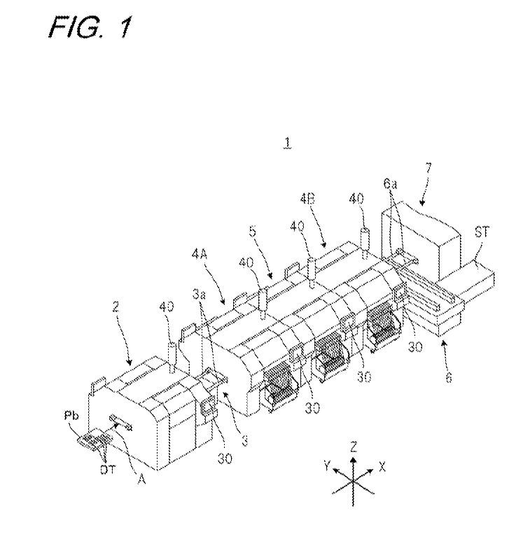

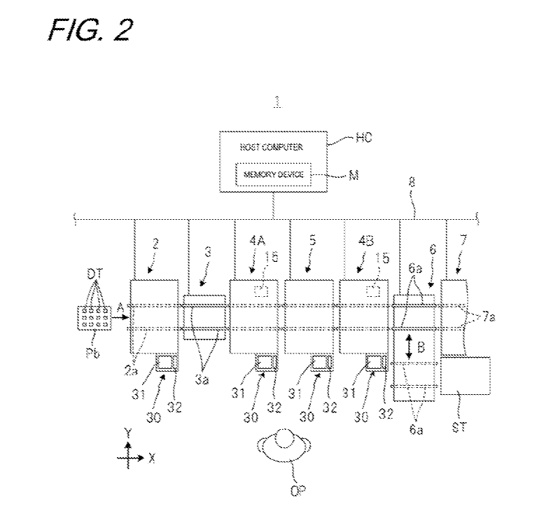

In FIGS. 1 and 2, a part-mounting system 1 of the first embodiment of the present invention is configured in such a way that a solder printer 2, a first substrate conveyor machine 3, a first inspection-machine-cum-part-mounting machine 4A, a part-mounting machine 5, a second an inspection-machine-cum-part-mounting machine 4B, a second substrate conveyor machine 6, and a reflow furnace 7 are arranged, as a plurality of pieces of apparatus for mounting parts, in this sequence along a direction of conveyance of a substrate Pb. The machines are linked together by means of a LAN cable 8 of a local area network (LAN) connected to a host computer HC, thereby being able to exchange information. For the sake of explanation, the direction of conveyance of the substrate Pb in the part-mounting system 1 is taken as an X-axis direction, and a horizontal in-plane direction orthogonal to the X-axis direction is taken as a Y-axis direction. Further, a vertical direction is taken as a Z-axis direction.

In FIGS. 1 and 2, the solder printer 2 receives the substrate Pb, loaded in the direction of arrow A shown in the drawing, by means of a substrate conveyor track 2a; conveys the thus-received substrate in the X-axis direction; positions the substrate at a working location; and then prints solder over electrodes DT provided on the substrate Pb (a solder printing process). After printing solder over the electrodes DT on the substrate Pb has finished, the substrate Pb is conveyed to the first substrate conveyor machine 3 that is a downstream machine, by means of the substrate conveyor track 2a. Thus, in the part-mounting system 1 of the first embodiment, the solder printer 2 serves as a solder printing portion that prints solder on the loaded substrate Pb.

In FIG. 2, the first substrate conveyor machine 3 receives the substrate Pb conveyed from the solder printer 2 that is an upstream machine, by means of a substrate conveyor track 3a; conveys the thus-received substrate in the X-axis direction; and conveys the substrate to the first inspection-machine-cum-part-mounting machine 4A that is a downstream machine.

The first inspection-machine-cum-part-mounting machine 4A and the second inspection-machine-cum-part-mounting machine 4B are identical in configuration with each other (differ from each other in terms of operation). The configuration of the first inspection-machine-cum-part-mounting machine 4A is described as a typical configuration.

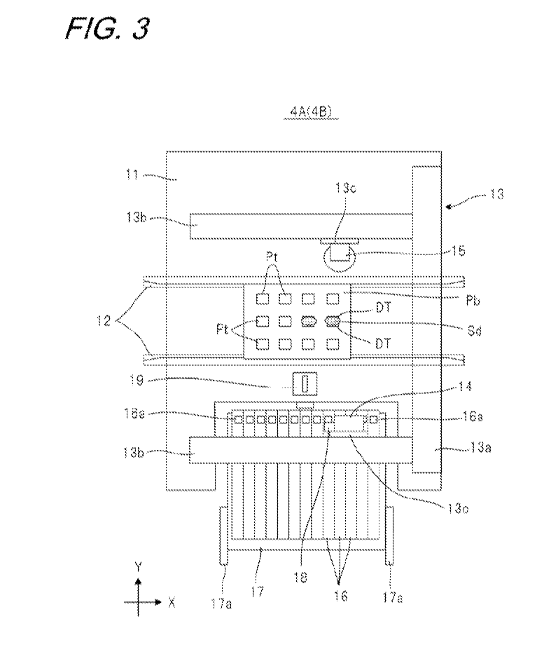

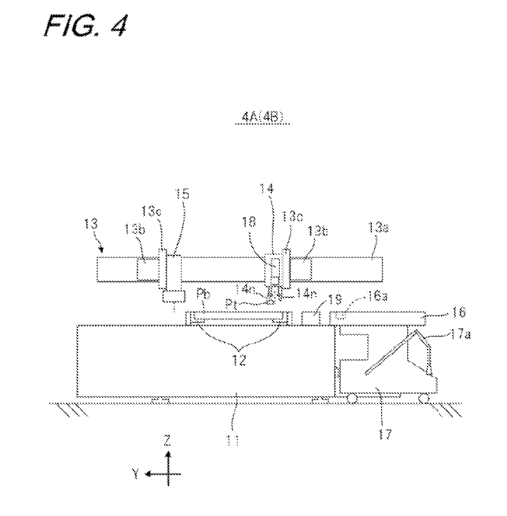

In FIGS. 3 and 4, the first inspection-machine-cum-part-mounting machine 4A is equipped with a substrate conveyor track 12 laid on a bench 11. The substrate conveyor track receives the substrate Pb conveyed out from the first substrate conveyor machine 3 that is an upstream machine (the part-mounting machine 5 for the second inspection-machine-cum-part-mounting machine 4B) and positions the thus-received substrate at a center working position (a position shown in FIG. 3) on the bench 11.

An XY robot 13 is placed on the bench 11, and a mount head 14 and an inspection camera 15 are independently movable by means of the XY robot 13. The XY robot 13 is built from a Y-axis table 13a extending in the Y-axis direction; two X-axis tables 13b that extend in the X-axis direction, that are supported at one end thereof by means of the Y-axis table 13a, and that are placed so as to be movable along the Y-axis table 13a (i.e., the Y-axis direction); and two movable stages 13c that are provided so as to be movable along the respective X-axis tables 13b (i.e., along the X-axis direction). The two movable stages 13c are separately provided with the mount head 14 and the inspection camera 15; namely, one stage with the mount head and the other stage with the camera.

In FIG. 4, a plurality of downwardly-extending pickup nozzles 14n are attached to a lower end of the mount head 14. The respective pickup nozzles 14n can move up and down with respect to the mount head 14 and turn around the vertical axis (i.e., the Z axis). With an imaging field of view oriented downwardly, the inspection camera 15 is secured to the movable stage 13c.

In FIGS. 3 and 4, a plurality of pieces of parts feeding apparatus (parts feeders) 16 for feeding parts Pt (FIGS. 3 and 4) to the mount head 14 are set side by side along the X-axis direction at one end where the mount head 14 is placed, among respective lateral ends of the bench 11 that oppose each other along the Y-axis direction with the substrate conveyor track 12 sandwiched therebetween. The plurality of parts feeders 16 are held by a carriage 17 that is removably attached to the bench 11. The plurality of parts feeders 16 can be collectively secured to the bench 11 by means of installing the carriage 17 to the bench 11. An operator OP (FIG. 2) operates a pair of wheels 17a, whereby the carriage 17 can move over a floor. The parts feeders 16 secured to the bench 11 consecutively feed the parts Pt to respective parts feed ports 16a opened at respective ends of the parts feeders facing the substrate conveyor track 12.

In FIGS. 3 and 4, a substrate camera 18 having a downwardly-oriented imaging field of view is set on the movable stage 13c equipped with the mount head 14, among the two movable stages 13c provided for the XY robot 13. A parts camera 19 having an upwardly-oriented imaging field of view is set in an area where the mount head 14 is secured, among both lateral areas of the substrate conveyor track 12 along the Y axis direction.

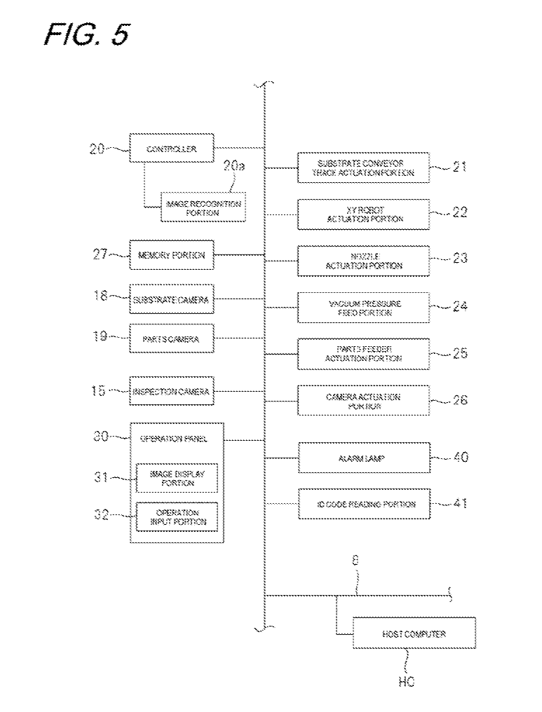

In FIG. 5, a control unit 20 provided in the first inspection-machine-cum-part-mounting machine 4A activates a substrate conveyor track actuation portion 21 that is made up of an unillustrated actuator, or the like, for actuating the substrate conveyor track 12, thereby conveying and positioning the substrate Pb. Further, the control unit activates an XY robot actuation portion 22 that is made up of an unillustrated actuator, or the like, for actuating the XY robot 13, thereby moving the mount head 14 and the inspection camera 15 within a horizontal plane. The control unit 20 also activates a nozzle actuation portion 23 that is made up of an unillustrated actuator, or the like, for actuating the respective pickup nozzles 14n, thereby moving up or down the respective pickup nozzles 14n with respect to the mount head 14 and also rotating the pickup nozzles around the vertical axis (the Z axis). The control unit further activates a vacuum pressure feed portion 24 that is made up of an unillustrated actuator, or the like, for feeding vacuum pressure to interiors of the respective pickup nozzles 14n, thereby bringing the interiors of the respective pickup nozzles 14n into a vacuum state or destroying the vacuum state. The respective pickup nozzles 14n thereby pick up or release the parts Pt.

The control unit 20 of the first inspection-machine-cum-part-mounting machine 4A activates a parts feeder actuation portion 25 that is made up of an unillustrated actuator, or the like, for actuating the respective parts feeders 16, thereby letting the respective parts feeders 16 perform operation for feeding parts to the respective parts feed ports 16a. The control unit also activates a camera drive portion 26 (FIG. 5), thereby controlling imaging operation of the inspection camera 15, the substrate camera 18, and the parts camera 19. Image data captured through imaging operations of the inspection camera 15, the substrate camera 18, and the parts camera 19 are taken and stored into a memory portion 27. The control unit 20 is linked to the host computer HC through the LAN cable 8 and capable of transmitting and receiving data to and from the host computer HC.

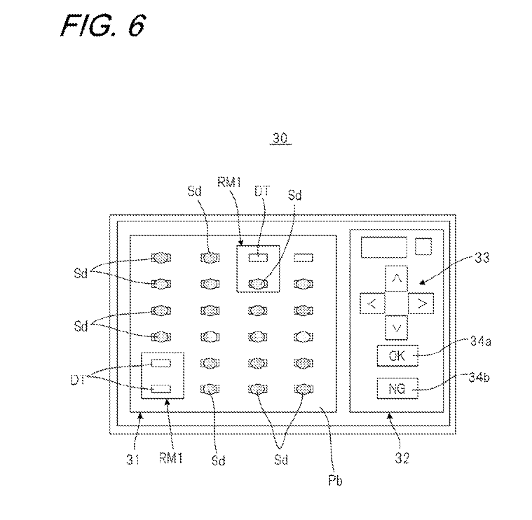

In FIGS. 1 and 2, an operation panel 30 serving as an input/output device is set on the bench 11 of the first inspection-machine-cum-part-mounting machine 4A (see also FIG. 5). As shown in FIG. 6, the operation panel 30 is equipped with an image display portion 31 on which an image is displayed and an operation input portion 32 through which the operator OP performs an input operation. In addition to including a plurality of arrow buttons 33 for performing required operation on an image appearing on the image display portion 31, the operation input portion 32 includes an OK button 34a and an NG button 34b for inputting a result of a judgment (which will be described later) made by the operator OP while the operator is viewing the image displayed on the image display portion 31. In FIG. 1, an alarm lamp 40 (see also FIG. 5) that is embodied by illumination of a lamp of red, or the like, as required, is provided at a predetermined location on a cover member that covers the bench 11. Incidentally, the operation panel 30 and the alarm lamp 40 are set in the solder printer 2, as well (see FIGS. 1 and 2).

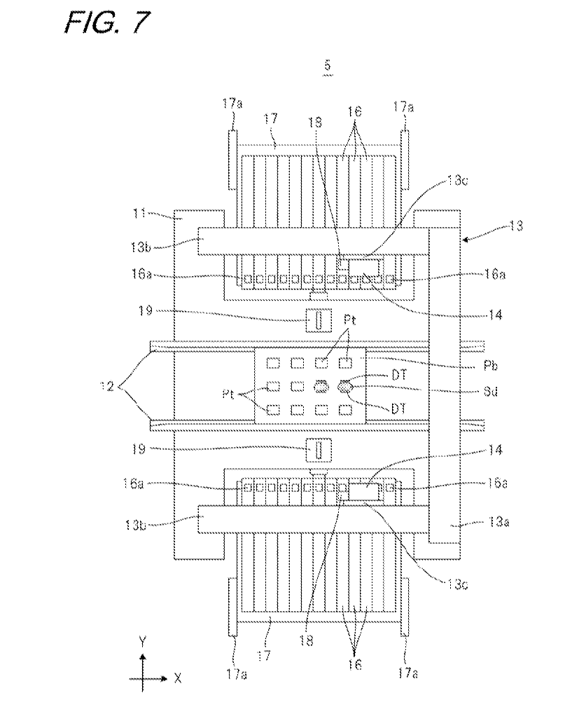

The configuration of the part-mounting machine 5 is now described. In terms of a configuration, the part-mounting machine 5 is substantially common to the first inspection-machine-cum-part-mounting machine 4A and the second inspection-machine-cum-part-mounting machine 4B. In FIGS. 7, 8, and 9, elements common to the configuration of the first inspection-machine-cum-part-mounting machine 4A and the second inspection-machine-cum-part-mounting machine 4B are assigned references identical with those shown in FIGS. 3, 4, and 5, and their explanations are omitted.

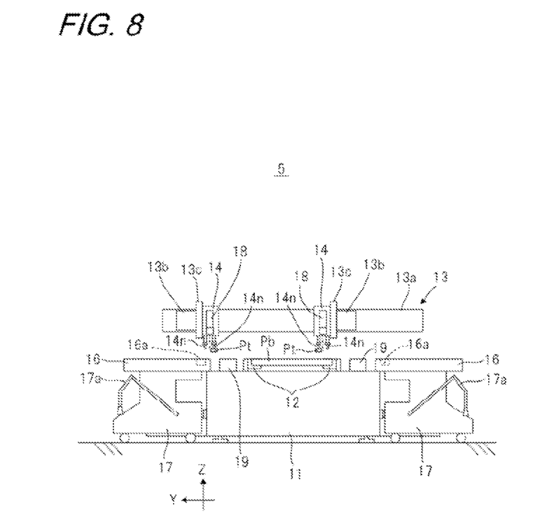

In FIGS. 7 and 8, differences between the part-mounting machine 5 and the first and second inspection-machine-cum-part-mounting machines 4A and 4B lie in that the mount head 14 is attached to both the two movable stages 13c (hence, the inspection camera 15 is not attached to the movable stage); that the plurality of parts feeders 16 for feeding the parts Pt to the respective mount heads 14 are disposed side by side at both ends of the bench 11, which oppose each other in the Y-axis direction with the substrate conveyor track 12 sandwiched therebetween, along the X-axis direction; that the substrate camera 18 having a downwardly-oriented imaging field of view is provided on each of the two movable stages 13c; and that the parts camera 19 having an upwardly-oriented imaging field of view is disposed on each of both lateral areas of the substrate conveyor track 12 along the Y-axis direction. Therefore, the part-mounting machine 5 is equipped with the operation panel 30 and the alarm lamp 40.

In FIGS. 1 and 2, the second substrate conveyor machine 6 receives, by means of a substrate conveyor track 6a, the substrate Pb conveyed out from the second inspection-machine-cum-part-mounting machine 4B that is an upstream machine; conveys the thus-received substrate in the X-axis direction; and conveys the substrate to the reflow furnace 7 that is a downstream machine. Under control of an unillustrated built-in control unit, the second substrate conveyor machine 6 can transfer the substrate conveyor track 6a in the Y-axis direction (see arrow B in FIG. 2).

Operation of the first inspection-machine-cum-part-mounting machine 4A, operation of the part-mounting machine 5, and operation of the second inspection-machine-cum-part-mounting machine 4B are now described. Upon detection of the substrate Pb (the substrate Pb printed with solder by the solder printer 2) carried out of the first substrate conveyor machine 3 that is an upstream machine, the control unit 20 of the first an inspection-machine-cum-part-mounting machine 4A activates the substrate conveyor track 12, to thus receive the substrate Pb, convey the thus-received substrate in the X-axis direction, and place the substrate at the working position. An ID code reading portion 41 (FIG. 5) reads at this time an ID code put on the substrate Pb. The substrate camera 18 (the mount head 14) is moved to an elevated position above a substrate mark (not shown) put on the substrate Pb and then capture an image of the substrate mark. An image recognition portion 20a (FIG. 5) subjects a captured image of the substrate mark to image recognition, thereby judging a position displacement in the substrate Pb (i.e., a position displacement from a normal working position for the substrate Pb). Incidentally, the inspection camera 15 can also capture an image of the substrate mark.

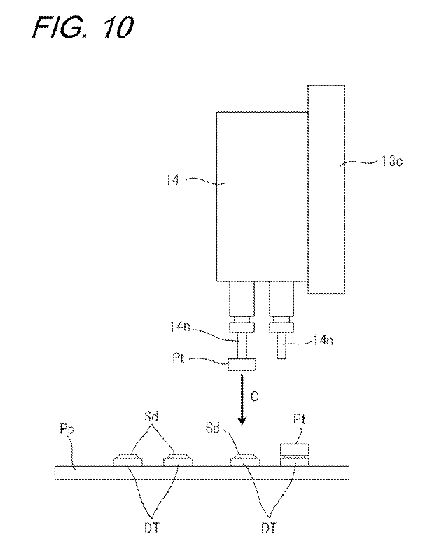

After having judged the position displacement in the substrate Pb, the control unit 20 of the first inspection-machine-cum-part-mounting machine 4A moves the inspection camera 15 to an elevated position above the substrate Pb; lets the camera capture images of respective locations on the substrate Pb; stores image data into the memory portion 27; and lets the image recognition portion 20a perform image recognition, to thus judge whether or not a print status of solder Sd on the electrodes DT achieved immediately after the solder has been printed by the solder printer 2 (see FIGS. 3 and 10) is nondefective (a solder print status inspection process). The case where the print status of the solder Sd is defective refers to a case where position displacements have taken place with respect to the electrodes DT, as well as referring to a case where the solder Sd is not at all printed on the electrodes DT.

When found a location where the print status of the solder Sd on the electrode DT is judged to be defective (a defective judgment location) as a result of processing pertaining to the solder print status inspection process having been performed, the control unit 20 of the first inspection-machine-cum-part-mounting machine 4A stores information about (a position and an image of) the defective judgment location into the memory portion 27 and transmits the information about the defective judgment location to the host computer HC through the LAN cable 8.

The host computer HC stores the information, transmitted from the first inspection-machine-cum-part-mounting machine 4A, about (the position and image of) the location where the print status of the solder Sd is judged to be defective, into a memory device M that is a memory portion of the host computer. Subsequently, the host computer also illuminates all or some of the alarm lamps 40 provided on the first inspection-machine-cum-part-mounting machine 4A, the part-mounting machine 5, and the second inspection-machine-cum-part-mounting machine 4B, through the control units 20 of these machines, thereby drawing attention of the operator OP. The host computer also causes the image display portions 31 of the operation panels 30 [i.e., all of the operation panels 30 (four panels) provided in the part-mounting system 1], which respectively belong to the first inspection-machine-cum-part-mounting machine 4A, the part-mounting machine 5, and the second inspection-machine-cum-part-mounting machine 4B, to display images of the defective judgment locations.

In this case, one of the image display portions 31 of the respective operation panels 30 displays; for instance, an image like that shown in FIG. 6. Further, the image display portion 31 displays an overall view of the substrate Pb, and the overall view includes the electrodes DT and the solder Sd printed on these electrodes DT. Of the solder Sd printed on the electrodes DT, the pieces of solder Sd located at defective judgment locations are assigned rectangular regional marks RM1.

When the image of the substrate Pb has appeared on the image display portion 31 of the operation panel 30, the operator OP judges, while viewing an image of a defective judgment location in the regional mark RM1, whether or not the defective judgment location is defective. The operator then inputs a judgment result by operation of an “OK” button 34a or an “NG” button 34b of the operation input portion 32. Specifically, when denying that the print status of the solder Sd at the defective judgment location displayed on the image display portion 31 is defective, the operator OP operates the “OK” button 34a of the operation input portion 32. When admitting that the print status of the solder Sd at the defective judgment location is defective, the operator OP operates the “NG” button 34b of the operation input portion 32. When the regional mark RM1 denoting a defective judgment location exists in numbers in the image of the substrate Pb displayed on the image display portion 31, the operator OP operates an arrow button 33 of the operation input portion 32, to thus fix an object of judgment, and subsequently operates the “OK” button 34a or the “NG” button 34b.

In relation to the defective judgment location, among the defective judgment locations, for which the operator OP has made an input to the effect that the print status of the solder Sd is not admitted to be defective through the operation input portion 32 of the operation panel 30 (i.e., the defective judgment location for which the “OK” button 34a is operated), the control unit 20 of the first inspection-machine-cum-part-mounting machine 4A deals with the defective judgment location as a good location (a nondefective location). In the meantime, the defective judgment location, among the defective judgment locations, for which the operator OP has made an input to the effect that the print status of the solder Sd is admitted to be defective through the operation input portion 32 of the operation panel 30 (i.e., the defective judgment location for which the “NG” button 34b is operated), the control unit 20 of the first inspection-machine-cum-part-mounting machine 4A deals with the defective judgment location as a no-good location (a defective location).

When dealing with the defective judgment location as a defective location, the control unit 20 of the first inspection-machine-cum-part-mounting machine 4A affixes a no-good mark to the defective location by use of unillustrated mark affixing means; stores data pertaining to a location of the defective judgment location (the defective location) on the substrate Pb into the memory portion 27; combines information to the effect that the defective location is found in the substrate Pb with an ID code of the substrate Pb; and transmits the information and the code to the host computer HC. The host computer HC stores into the memory device M the data that pertain to the location where the print status of the solder Sd is defective and that have been transmitted from the control unit 20 of the first an inspection-machine-cum-part-mounting machine 4A; combines the data pertaining to the position of the defective location with the ID code of the substrate Pb; transmits the data and the ID code to the control unit 20 of the part-mounting machine 5 and the control unit 20 of the second inspection-machine-cum-part-mounting machine 4B; combines the ID code of the substrate with information to the effect that the defective location is found in the substrate Pb; and transmits the ID code and the information to a control unit of the second substrate conveyor machine 6.

After performing processing pertaining to the solder print status inspection process and dealing with the defective judgment location, which has been judged to be defective by the operation OP, as the defective location, the control unit 20 of the first inspection-machine-cum-part-mounting machine 4A conveys the substrate Pb including the defective judgment location to the part-mounting machine 5, without mounting the parts Pt on the substrate, that is a downstream machine. In contrast, in relation to the substrate Pb that is free from a defective judgment location, parts Pt are mounted to locations for which the first inspection-machine-cum-part-mounting machine 4A has charge of mounting parts Pt (a part-mounting process). Processing pertaining to the part-mounting process is performed by repetition of operation for feeding a part Pt to the parts feeder 16, moving the mount head 14, and picking up the part Pt from the parts feeder 16 and operation for releasing the thus-picked-up part Pt at an elevated position above the electrode DT printed with the solder Sd on the substrate Pb.

Explanations are now given to procedures of the part-mounting process from operation for picking up the part Pt to operation for releasing the part at an elevated position above the substrate Pb (mounting the part on the substrate Pb). The control unit 20 of the first inspection-machine-cum-part-mounting machine 4A first moves the mount head 14 to an elevated position above the parts feed port 16a of the parts feeder 16; lets the pickup nozzle 14n descend or ascend with respect to the mount head 14; and brings the interior of the pickup nozzle 14n into a vacuum state when the pickup nozzle 14n has contacted an upper surface of the part Pt, thereby causing the pickup nozzle 14n to pick up the part Pt. The mount head 14 (i.e., the pickup nozzle 14n) thereby picks up the part Pt.

After the part Pt has been picked up as mentioned above, the control unit 20 of the first inspection-machine-cum-part-mounting machine 4A moves the mount head 14 in such a way that the part Pt comes to a position immediately above the parts camera 19; and lets the parts camera 19 capture an image of the parts Pt. The control unit 20 stores into the memory portion 27 image data that pertain to the part Pt and that have been captured by the parts camera 19. The image recognition portion 20a recognizes an image, to thus inspect whether or not an anomaly (deformation, a deficit, or the like) exists in the part Pt. Further, position displacement (pickup displacement) in the part Pt with respect to the pickup nozzle 14n is now calculated.

After having subjected the part Pt to image recognition as mentioned above, the control unit 20 of the first inspection-machine-cum-part-mounting machine 4A moves the mount head 14 in such a way that the part Pt picked up by the pickup nozzle 14n comes to a position immediately above a target mounting position (the position where the electrode DT is provided) on the substrate Pb (FIG. 10). The control unit causes the pickup nozzle 14n to descend with respect to the mount head 14 (as designated by arrow C in FIG. 10) and ascend. When the part Pt has contacted the electrode DT, the interior vacuum state of the pickup nozzle 14n is broken: Thereby, the part Pt held in a picked-up state by the pickup nozzle 14n is released, whereupon the part Pt is released from the pickup nozzle 14n, and the part Pt is mounted on the electrode DT on the substrate Pb. When the part Pt is mounted on the electrode DT, a correction (including a rotational correction) is made to the position of the pickup nozzle 14n with respect to the substrate Pb in such a way that the previously-determined position displacement in the substrate Pb and pickup displacement in the part Pt are corrected.

After all of the parts Pt to be mounted on the substrate Pb have been mounted on the substrate Pb, the control unit 20 of the first inspection-machine-cum-part-mounting machine 4A activates the substrate conveyor track 12, thereby carrying the substrate Pb out to the part-mounting machine 5 that is a downstream machine.

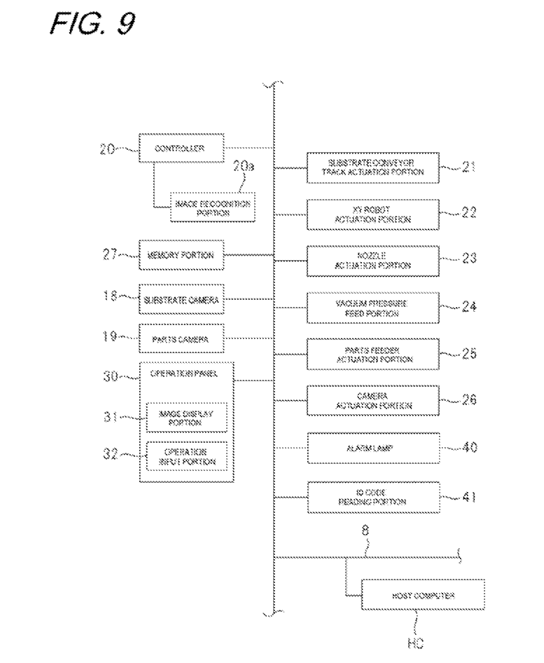

Upon detection of the substrate Pb carried out of the first inspection-machine-cum-part-mounting machine 4A, the control unit 20 of the part-mounting machine 5 activates the substrate conveyor track 12, to thus receive the substrate Pb. The control unit 20 then conveys the substrate in the X-axis direction and places the thus-conveyed substrate at the working position (the position shown in FIG. 7). The ID code reading portion 41 (FIG. 9) at this time reads the ID code affixed on the substrate Pb. Through the same procedures as those employed for the case of the first inspection-machine-cum-part-mounting machine 4A, the position displacement in the substrate Pb is determined. Subsequently, the two mount heads 14 perform processing pertaining to the same part-mounting process as that the first inspection-machine-cum-part-mounting machine 4A has performed for the substrate Pb.

In the part-mounting process, the control unit 20 of the part-mounting machine 5 conveys the substrate Pb including the position where the print status of the solder Sd is judged to be defective by the operator OP (data pertaining to the substrate Pb including such a defective judgment location are received from the host computer HC as mentioned above) to the second inspection-machine-cum-part-mounting machine 4B that is a downstream machine without mounting the part Pt. In contrast, in relation to the substrate Pb that is free from a location where the print status of the solder Sd is judged to be defective by the operator OP, the control unit 20 mounts parts Pt to locations for which the part-mounting machine 5 has charge of mounting parts Pt. After having finished processing pertaining to the process for mounting parts on the substrate Pb, the control unit 20 of the part-mounting machine 5 conveys the substrate Pb to the second inspection-machine-cum-part-mounting machine 4B that is a downstream machine.

Upon detection of the substrate Pb carried out of the part-mounting machine 5 that is an upstream machine, the control unit 20 of the second inspection-machine-cum-part-mounting machine 4B activates to the substrate conveyor track 12, to thus receive the substrate Pb. The control unit 20 subsequently conveys the substrate in the X-axis direction, to thus place the substrate at the working position. The ID code reading portion 41 (FIG. 5) reads the ID code put on the substrate Pb. Through the same procedures as those employed for the first inspection-machine-cum-part-mounting machine 4A, position displacement in the substrate Pb is determined, and the mount head 14 performs processing pertaining to the part-mounting process. In the part-mounting process, the control unit 20 of the second inspection-machine-cum-part-mounting machine 4B conveys the substrate Pb including the position where the print status of the solder Sd is judged to be defective by the operator OP (data pertaining to the substrate Pb including such a defective judgment location are received from the host computer HC as mentioned above) to the second substrate conveyor machine 6 that is a downstream machine without mounting the part Pt. In contrast, in relation to the substrate Pb that is free from a location where the print status of the solder Sd is judged to be defective by the operator OP, parts Pt are mounted to locations for which the second inspection-machine-cum-part-mounting machine 4B has charge of mounting parts Pt.

After completion of processing pertaining to the part-mounting process, the control unit 20 of the second inspection-machine-cum-part-mounting machine 4B moves the inspection camera 15 to an elevated position above the substrate Pb; lets the camera capture images of respective locations on the substrate Pb; stores image data into the memory portion 27; and lets the image recognition portion 20a (FIG. 5) perform image recognition, to thus let the part-mounting portion of the first inspection-machine-cum-part-mounting machine 4A (i.e., the mount head 14 and the control unit 20 provided for the first inspection-machine-cum-part-mounting machine 4A), the part-mounting portion of the part-mounting machine 5 (i.e., the mount head 14 and the control unit 20 of the part-mounting machine 5), and the part-mounting portion of the second inspection-machine-cum-part-mounting machine 4B (the mount head 14 and the control unit 20 of the second inspection-machine-cum-part-mounting machine 4B) judge whether or not a mounted state of the parts Pt mounted on the electrodes DT of the substrate Pb is defective (a parts mounted status inspection process). The case where the mounted status of the parts Pt is defective refers to a case where position displacements with respect to the electrodes DT exist in parts even when the parts are mounted on the electrodes and where the parts are deformed or impaired and a case where the parts are deformed or impaired, as well as referring to a case where the parts Pt are not mounted on the electrodes DT.

When found a location where the mounted status of the parts Pt on the electrode DT is judged to be defective (a defective judgment location) as a result of having performed processing pertaining to the parts mounted status inspection process, the control unit 20 of the second inspection-machine-cum-part-mounting machine 4B stores information about (a position and an image of) the defective judgment location into the memory portion 27 and transmits the information about the defective judgment location to the host computer HC through the LAN cable 8.

The host computer HC stores the information, transmitted from the second inspection-machine-cum-part-mounting machine 4B, about (the position and image of) the location where the mounted status of the parts Pt is judged to be defective, into the memory device M. Subsequently, the host computer also illuminates all or some of the alarm lamps 40 provided on the first inspection-machine-cum-part-mounting machine 4A, the part-mounting machine 5, and the second inspection-machine-cum-part-mounting machine 4B, through the control units 20 of these machines, thereby drawing attention of the operator OP. The host computer also causes the image display portions 31 of the operation panels 30 [i.e., all of the operation panels 30 (four panels) provided in the part-mounting system 1], which respectively belong to the first inspection-machine-cum-part-mounting machine 4A, the part-mounting machine 5, and the second inspection-machine-cum-part-mounting machine 4B, to display images of the defective judgment locations.

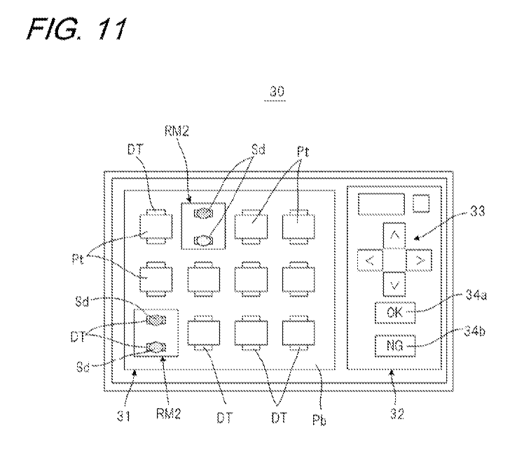

In this case, one of the image display portions 31 of the respective operation panels 30 displays; for instance, an image like that shown in FIG. 11. Further, the image display portion 31 displays an overall view of the substrate Pb, and the overall view includes the electrodes DT and the parts Pt mounted on these electrodes DT. Of the parts Pt mounted on the electrodes DT, the parts at the defective judgment locations are assigned rectangular regional marks RM2.

When the image of the substrate Pb has appeared on the image display portion 31 of the operation panel 30, the operator OP judges, while viewing an image of a defective judgment location in the regional mark RM2, whether or not the defective judgment location is defective. The operator then inputs a judgment result by operation of the “OK” button 34a or the “NG” button 34b of the operation input portion 32. Specifically, when denying that the mounted status of the parts Pt at the defective judgment location displayed on the image display portion 31 is defective, the operator OP operates the “OK” button 34a of the operation input portion 32. When admitting that the mounted status of the parts Pt at the defective judgment location is defective, the operator OP operates the “NG” button 34b of the operation input portion 32. When the regional mark RM2 denoting a defective judgment location exists in numbers in the image of the substrate Pb displayed on the image display portion 31, the operator operates the arrow button 33 of the operation input portion 32, to thus fix an object of judgment, and subsequently operates the “OK” button 34a or the “NG” button 34b in much the same way that a judgment is made as to whether or not the print status of the solder Sd is defective.

In relation to the defective judgment location, among the defective judgment locations, for which the operator OP has made an input to the effect that the mounted status of the parts Pt is not admitted to be defective through the operation input portion 32 of the operation panel 30 (i.e., the defective judgment location for which the “OK” button 34a is operated), the control unit 20 of the second inspection-machine-cum-part-mounting machine 4B deals with the defective judgment location as a good location (a nondefective location). In the meantime, the defective judgment location, among the defective judgment locations, for which the operator OP has made an input to the effect that the mounted status of the parts Pt is admitted to be defective through the operation input portion 32 of the operation panel 30 (i.e., the defective judgment location for which the “NG” button 34b is operated), the control unit 20 of the second inspection-machine-cum-part-mounting machine 4B deals with the defective judgment location as a no-good location (a defective location).

When dealing with the defective judgment location as a defective location, the control unit 20 of the second inspection-machine-cum-part-mounting machine 4B affixes a no-good mark to the defective location by use of the unillustrated mark affixing means; combines information to the effect that the defective location is found in the substrate Pb with an ID code of the substrate Pb; and transmits the information and the code to the host computer HC. The host computer HC combines information, which has been transmitted from the control unit 20 of the second inspection-machine-cum-part-mounting machine 4B and which means that the defective location is found in the substrate Pb with the ID code of the substrate Pb, and transmits the information and the ID code to the control unit of the second substrate conveyor machine 6.

After performing processing pertaining to the parts mounted status inspection process and dealing with the defective judgment location, which has been judged to be defective by the operation OP, as the defective location, the control unit 20 of the second inspection-machine-cum-part-mounting machine 4B activates the substrate conveyor track 12, thereby carrying the substrate Pb to the second substrate conveyor machine 6 that is a downstream machine.

In relation to the substrate Pb for which information meaning that the defective location has been found is not received from the host computer HC (i.e., the substrate Pb not having the appearance of being given a defective mark), among the substrates Pb carried out of the second inspection-machine-cum-part-mounting machine 4B that is an upstream machine, the control unit of the second substrate conveyor machine 6 conveys the substrate Pb to the reflow furnace 7 by means of the substrate conveyor track 6a. The reflow furnace 7 receives the substrate Pb carried out of the second substrate conveyor machine 6 (i.e., the substrate Pb having finished being mounted with the parts Pt) by means of a substrate conveyor track 7a (FIG. 1) and subjects the solder Sd on the substrate Pb to reflow while conveying the substrate Pb in the X-axis direction. The substrate Pb having undergone reflow of the solder Sd is carried downstream out of the substrate conveyor track 7a. The substrate Pb carried out of the reflow furnace 7 undergoes final inspection in an unillustrated appearance inspection machine. Upon being judged to be normal through the final inspection, the substrate Pb is collected as a good substrate. In contrast, upon being judged to be anomalous, the substrate Pb is collected as a no-good substrate.

In the meantime, in relation to the substrate Pb for which information meaning that the defective location has been found is received from the host computer HC (i.e., the substrate Pb having the appearance of being given a defective mark), among the substrates Pb carried out of the second inspection-machine-cum-part-mounting machine 4B, the control unit of the second substrate conveyor machine 6 moves the substrate Pb along the substrate conveyor track 6 in the Y-axis direction and subsequently conveys the substrate to a repair station ST (FIGS. 1 and 2) placed at a location out of a production line of the part-mounting system 1 (in a neighborhood of the reflow furnace 7). Among the defective locations, given the defective marks, on the substrate Pb conveyed to the repair station ST, the locations where the mounted status of the parts Pt is defective are manually mounted with the parts Pt by the operator OP (also repainted with the solder Sd when required).

After having finished making repairs on the defective locations, the operator OP loads (reloads) the substrate Pb into the second substrate conveyor machine 6 in order to return the repaired substrate Pb to the production line of the part-mounting system 1. In relation to the substrate Pb conveyed to the repair station ST without being mounted with the parts Pt as result of having been judged to include defectively printed solder Sd, the operator OP loads (reloads) the substrate Pb to the solder printer 2 in order to reprint the solder Sd on the substrate Pb.

As mentioned above, the mount head 14 and the control unit 20 of the first inspection-machine-cum-part-mounting machine 4A, the mount head 14 and the control unit 20 of the part-mounting machine 5, and the mount head 14 and the control unit 20 of the second inspection-machine-cum-part-mounting machine 4B make up a part-mounting portion in the part-mounting system 1, where the parts Pt are mounted on the substrate Pb printed with the solder Sd by the solder printer 2 serving as the solder printing portion.

Further, the inspection camera 15 and the control unit 20 of the first inspection-machine-cum-part-mounting machine 4A, the inspection camera 15 and the control unit 20 of the second inspection-machine-cum-part-mounting machine 4B make up, in the part-mounting system 1, an inspection portion that captures an image of the solder Sd printed on the substrate Pb by the solder printing portion or an image of the parts Pt mounted on the substrate Pb by the part-mounting portion and judges from the thus-acquired image whether or not the print status of the solder Sd on the substrate Pb or the mounted state of the parts Pt on the substrate Pb is defective. The host computer HC acts as display controller that displays, on all of the image display portions 31 of the plurality of operation panels 30, an image of the location on the substrate Pb where the print status of the solder Sd or the mounted status of the parts is judged as being defective by the inspection portion.

As mentioned above, in the part-mounting system 1 of the first embodiment, the image of the location where the print status of the solder Sd or the mounted status of the parts Pt is judged as being defective by the inspection portion on the substrate Pb is displayed on all of the image display portions 31 of the plurality of (four) operation panels 30 (input/output devices). Through the operation input portion 32 of the operation panel 30 including the image display portion 31 on which the image of the defective judgment location is displayed, the operator OP can input a result (a judgment result) of the judgment made as to whether or not the print status of the solder Sd or the mounted status of the parts Pt at the defective judgment location is defective.

For this reason, even if the operator OP is away from the inspection portion (the first inspection-machine-cum-part-mounting machine 4A during inspection of the print status of the solder Sd or the second inspection-machine-cum-part-mounting machine 4B during inspection of the mounted status of the parts Pt) when the inspection portion has found the defective judgment location, the operator OP can quickly check the defective judgment location and input a result of judgment of the defective judgment location. Thus, a necessity for the operator OP moving to the inspection portion is obviated; hence, the halt of operation of the part-mounting system 1 is prevented, so that deterioration of productivity of mounted substrates can be prevented.

In the above descriptions, the host computer HC serving as display controller is configured so as to display, on all of the image display portions 31 of the plurality of operation panels 30, an image of the defective judgment location on the substrate Pb where the print status of the solder Sd or the mounted status of the parts is judged as being defective by the inspection portion. In place of such a configuration, an image of the defective judgment location on the substrate Pb where the print status of the solder Sd or the mounted status of the parts is judged as being defective by the inspection portion may also be displayed on some of the image display portions 31 selected from the plurality of operation panels 30 by the operator OP. In this case, however, another example configuration can also be adopted. Namely, when the operator OP whose attention was withdrawn by illumination of the alarm lamps 40 has performed a predetermined input operation through the operation input portion 32 of an arbitrary operation panel 30 (usually an operation panel on which the operator OP is in operation or an operation panel located in closest proximity to the operator at that time), the host computer HC received the input operation displays the image of the defective judgment location on the image display portion 31 of the operation panel 30 where the operation input was performed.

Furthermore, when displaying the image of the defective judgment location on the image display portion 31 of the operation panel 30 selected by the operator OP, the host computer HC may impart relevant operation command information, or the like, to the image display portion 31 adjacent to the operation panel 30 (provided on an adjacent machine) as well as to the image display portion 31 of the operation panel 30 selected by the operator OP. For instance, when the operator OP has selected the operation panel 30 provided in the part-mounting machine 5, a locally enlarged image of the defective judgment location is displayed as main information on the image display portion 31 of the operation panel 30 provided in the part-mounting machine 5 so that the operator OP can readily judge whether or not the defective judgment location is defective. The image display portion 31 of the operation panel 30 of the adjacent first inspection-machine-cum-part-mounting machine 4A (or the second inspection-machine-cum-part-mounting machine 4B or both the first inspection-machine-cum-part-mounting machine 4A and the second inspection-machine-cum-part-mounting machine 4B) displays, as sub-information, information that shows a location of the defective judgment location in the entire substrate Pb (e.g., an image of the entire substrate Pb) or statistical data, or the like, pertaining to the locations on the substrate Pb easily judged to be defective.

### Second Embodiment

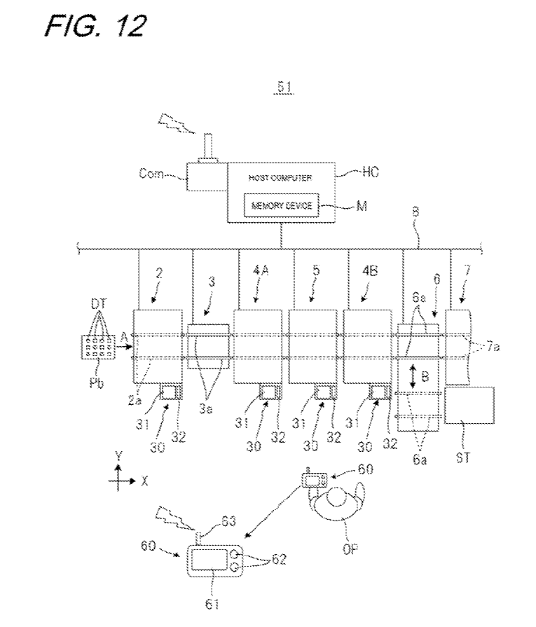

In FIG. 12, a part-mounting system 51 of a second embodiment has a configuration realized by adding a portable terminal 60 carried by the operator OP to the part-mounting system 1 of the first embodiment and adding a communication portion Com, which enables establishment of a communication with the portable terminal 60, to the host computer HC serving as display controller.

The portable terminal 60 includes a display 61 on which an image is displayed, an input portion 62 through which the operator OP performs input operation, and a communication portion 63 that establishes a communication with the communication portion Com of the host computer HC. The host computer HC is configured so as to display on the display 61 of the portable terminal 60 an image of the defective judgment location on the substrate Pb on which the print status of the solder Sd or the mounted status of the parts Pt is judged to be defective by the inspection portion. Viewing the image of the defective judgment location appearing on the display 61, the operator OP judges whether or not the defective judgment location is defective and inputs a judgment result through the input portion 62.

When an input to the effect that the print status of the solder Sd at the defective judgment location appearing on the display 61 of the portable terminal 60 is not admitted to be defective has been made through the input portion 62 of the portable terminal 60, the control unit 20 of the first inspection-machine-cum-part-mounting machine 4A making up the inspection portion deals with the defective judgment location as a good location. In contrast, when an input to the effect that print status of the solder Sd at the defective judgment location is admitted to be defective has been made, the control unit deals with the defective judgment location as a defective location.

When an input to the effect that the mounted status of the parts Pt at the defective judgment location appearing on the display 61 of the portable terminal 60 is not admitted to be defective has been made through the input portion 62 of the portable terminal 60, the control unit 20 of the second inspection-machine-cum-part-mounting machine 4B making up the inspection portion deals with the defective judgment location as a good location. In contrast, when an input to the effect that mounted status of the parts Pt at the defective judgment location is admitted to be defective has been made, the control unit deals with the defective judgment location as a defective location.

Even the part-mounting system 51 of such a configuration can also yield the same advantage as that yielded by the part-mounting system 1 of the first embodiment. In addition, even when the operator OP is away from the part-mounting system 51, the operator can quickly ascertain the defective judgment location and input a result of judgment of the defective judgment location.

Although the embodiments of the present invention have been described thus far, the present invention is not limited to the foregoing embodiments. In the embodiments, the number of part-mounting machine 5 making up the part-mounting portion is one, but specific limitations are not imposed on the number of part-mounting machines 5. Moreover, specific limitations are not imposed on the number of the inspection-machine-cum-part-mounting machines, either. Further, the foregoing embodiments are configured such that the inspection portion that performs an inspection of a print status of the solder Sd (the inspection camera 15 and the control unit 20 of the first inspection-machine-cum-part-mounting machine 4A) is arranged in the same machine (i.e., the first inspection-machine-cum-part-mounting machine 4A) where the part-mounting portion (the mount head 14 and the control unit 20 of the first inspection-machine-cum-part-mounting machine 4A) is placed. Furthermore, the inspection portion that performs an inspection of the mounted status of the parts Pt (the mount head 14 and the control unit 20 of the second inspection-machine-cum-part-mounting machine 4B) is arranged in the same machine (i.e., the second inspection-machine-cum-part-mounting machine 4B) where the part-mounting portion (the mount head 14 and the control unit 20 of the second inspection-machine-cum-part-mounting machine 4B) is placed. However, adopting such a configuration is not always necessitated. The inspection portion and the part-mounting portion can also be built from mutually-different machines (e.g., the inspection portion can be built from an inspection machine specifically designed for inspection, and the part-mounting portion can also be built from a part-mounting machine specifically designed for mounting parts).

The present invention is also expected to be susceptible to various alterations or applications conceived by the skilled in the art without departing the gist and scope of the present invention and on the basis of the specifications of the present specification and the well-known techniques. The present invention falls within a range where protection of the present invention is sought. Moreover, arbitrary combinations of the respective constituent elements described in connection with the embodiments may also be achieved without departing the scope of the present invention.

The present patent application is based on a Japanese Patent Application No. 2009-234040 filed on Oct. 8, 2009 in Japan, the entire subject matter of which is incorporated herein by reference.

### INDUSTRIAL APPLICABILITY

There is provided a part-mounting system that makes it possible to quickly ascertain defective judgment location and input a result of judgment of the defective judgment location even if an operator is away from an inspection portion when the inspection portion has found a defective judgment location.

### DESCRIPTIONS OF THE REFERENCE NUMERALS AND SYMBOLS

1 PART-MOUNTING SYSTEM
2 SOLDER PRINTER (SOLDER PRINTING PORTION)
14 MOUNT HEAD (PARS MOUNTING PORTION)
15 INSPECTION CAMERA (INSPECTION PORTION)
20 CONTROL UNIT (PART-MOUNTING PORTION, INSPECTION LOCK)
30 OPERATION PANEL (INPUT/OUTPUT DEVICE)
31 OPERATION INPUT PORTION
Pb SUBSTRATE
Sd SOLDER
Pt PARTS
HC HOST COMPUTER (DISPLAY CONTROLLER)
60 PORTABLE TERMINAL
61 DISPLAY
62 INPUT PORTION
OP OPERATOR

1. A part-mounting system comprising:
a solder printing portion that prints solder on a loaded substrate;
a part-mounting portion that mounts parts on the substrate printed with the solder by the solder printing portion;
an inspection portion that captures an image of the solder printed on the substrate by the solder printing portion or an image of the parts mounted on the substrate by the part-mounting portion and that judges from the captured image whether or not a print status of the solder on the substrate or a mounted status of the parts on the substrate is defective;
a plurality of input/output devices that each have an image display portion for displaying an image and an operation input portion through which an operator performs input operation; and
a display controller that lets all of the image display portions of the plurality of input/output devices or some of the image display portions selected by the operator display an image of a defective judgment location on the substrate where the print status of the solder or the mounted status of the parts is judged to be defective by the inspection portion, wherein
the inspection portion deals with the defective judgment location as a no-good location when an input meaning that the print status of the solder or the mounted status of the parts at the defective judgment location displayed on the image display portions is admitted to be defective has been made through the operation input portion of the input/output device having the image display portion on which the image of the defective judgment location is displayed by the display controller, and deals with the defective judgment location as a good location when an input meaning that the print status of the solder or the mounted status of the parts at the defective judgment location displayed on the image display portions is not admitted to be defective has been made.

2. The part-mounting system according to claim 1, further comprising:
a portable terminal that is carried by the operator and that includes a display for displaying an image and an input portion through which the operator performs input operation, wherein the display controller displays, on the display of the portable terminal, an image of the defective judgment location on the substrate where the print status of the solder or the mounted status of the parts is judged to be defective by the inspection portion; and wherein
the inspection portion deals with the defective judgment location as a no-good location when an input meaning that the print status of the solder or the mounted status of the parts at the defective judgment location displayed on the display of the portable terminal is admitted to be defective has been made through the input portion of the portable terminal, and deals with the defective judgment location as a good location when an input meaning that the print status of the solder or the mounted status of the parts at the defective judgment location displayed on the display of the portable terminal is not admitted to be defective has been made.
